(19) United States
(12) Patent Application Publication
(10) Pub. No.: US 2017/0184522 A1
(43) Pub. Date: Jun. 29, 2017

(54) STABILITY EVALUATION TEST DEVICE AND STABILITY EVALUATION TEST METHOD FOR ELECTRIC STORAGE DEVICE

(71) Applicant: Mitsubishi Electric Corporation, Chiyoda-ku (JP)

(72) Inventors: Makiko KISE, Chiyoda-ku (JP); Shinji BADONO, Chiyoda-ku (JP); Shoji YOSHIOKA, Chiyoda-ku (JP)

(73) Assignee: Mitsubishi Electric Corporation, Chiyoda-ku (JP)

(21) Appl. No.: 15/039,075

(22) PCT Filed: Sep. 3, 2014
(86) PCT No.: PCT/JP2014/073193

§ 371 Date: May 25, 2016

(30) Foreign Application Priority Data
Dec. 20, 2013 (JP) 2013-263675

(51) Int. Cl. G01N 25/20; H01M 10/48; H01M 10/42

(52) U.S. Cl. CPC G01N 25/20; H01M 10/4285; H01M 10/486

(57) ABSTRACT

A stability evaluation test device includes: an operation/test control unit that sets an SOC of a test electric storage device to an established value, and sets an SOC of a thermal standard electric storage device to a value lower than that of the SOC of the test electric storage device; a test data collection unit that measures a temperature of the test electric storage device and the thermal standard electric storage device; and an evaluation and analysis unit that calculates respective self-generated heat amounts of the test electric storage device and the thermal standard electric storage device on the basis of the temperatures of the electric storage devices, and evaluates the stability of the test electric storage device on the basis of a ratio of the self-generated heat amounts of the test electric storage device and of the thermal standard electric storage device.

### TECHNICAL FIELD

This invention relates to a stability evaluation test device and a stability evaluation test method for an electric storage device, for performing a stability evaluation test on an electric storage device including a lithium ion battery or the like.

### BACKGROUND ART

Against the backdrop of a low-carbon society, recent years have witnessed the ongoing development of electric storage devices such as secondary batteries, for instance, nickel hydride batteries and lithium ion batteries, as well as electrical double layer capacitors and fuel cells. Among the foregoing, lithium ion batteries are increasingly used not only in conventional portable devices but also as large-equipment power sources in EVs, HEVs and for system interconnection in smart grids and the like.

The size and capacity of lithium ion batteries that are used as large-equipment power sources are becoming greater than those of conventional power sources for portable devices. When selecting such large-capacity batteries it is essential to assess not only the characteristics and life of the battery, but also reliability and stability in terms of thermal stability and electrical stability. Among various electric storage devices, lithium ion batteries have high energy density and may experience thermal runaway in cases where internal short-circuits occur due to problems such as article misuse or production defects.

Accordingly, the safety of lithium ion batteries is regulated by domestic and international standards (see for instance Non-patent literature 1). These standards prescribe test methods and test conditions for conducting various stability evaluation tests on lithium ion batteries.

The evaluation method of Non-patent literature 1, however, involved a good/no-good evaluation scheme in which a stability evaluation test is performed under given test conditions, in accordance with an established test method, to determine the occurrence or absence of fire or bursting. This was accordingly problematic in that stability could not be evaluated quantitatively.

In the light of this problem, therefore, methods have been proposed that involve carrying out a stability evaluation test, ranking the content of the occurring events according to a plurality of grades, and classifying stability into levels on the basis of that ranking (see for instance Non-patent literature 2).

In Non-patent literature 2, however, a plurality of batteries of completely identical specifications did not necessarily yield identical event contents for all batteries even when the batteries were subjected to an evaluation test under identical conditions. This was problematic in that quantifying battery stability on the basis of the content of the occurred events was extremely difficult.

In view of such problems, a method has been therefore proposed that involves evaluating the thermal stability of a lithium ion battery and the constituent materials thereof by performing thermal analysis on a lithium secondary battery structure that results from arranging a positive electrode and a negative electrode capable of storing and releasing lithium ions opposing each other, with a separator interposed therebetween, the lithium secondary battery structure comprising a nonaqueous electrolyte solution that exhibits lithium ion conductivity (see for instance Patent Literature 1).

In Patent Literature 1, the thermal stability of a material is evaluated quantitatively by using a lithium ion battery structure being a reference specimen that is made up of at least one or more materials different from a material that makes up a test specimen, and by comparing heat generation amounts of the reference specimen and of the test specimen.

### CITATION LIST

### Patent Literature

[PTL 1]
Japanese Patent Application Publication No. 2010-97835

### Non Patent Literature

[NPL 1]
“Secondary lithium cells and batteries for use in industrial applications—Part 2: Tests and requirements of safety”, JIS C 8715-2, Japanese Industrial Standards
[NPL 2]
Daniel H. Doughty et al. “FreedomCAR Electrical Energy Storage System Abuse Test Manual for Electric and Hybrid Electric Vehicle Applications”, SAND 2005-3123, August 2006

### SUMMARY OF INVENTION

### Technical Problem

Conventional technologies however have the following problems. Although the method disclosed in Patent Literature 1 allows quantifying the heat generation amounts of constituent members such as the electrodes, separator and electrolyte solution, and of the battery structure that is a combination of the foregoing, the thermal stability of the actual battery varies nevertheless depending on heat absorption and release derived from the material of the battery exterior, heat dissipation derived from the shape of the battery, as well as the ratios of the members inside the battery structure.

Accordingly, the thermal stability of the actual battery cannot be evaluated, which is problematic. A further problem arises in that an analyzer such as a calorimeter is required to measure heat generation amounts. Yet another problem is that most actual batteries are too large to be set in analyzers.

In view of the above, it is an object of the present invention to provide a stability evaluation test device and stability evaluation test method for an electric storage device that allows collecting necessary and appropriate data for, when performing a stability evaluation test, evaluating the stability of a test electric storage device, and performing detailed evaluation analysis on the basis of the data collection results, to thereby evaluate quantitatively the electric storage device.

### Solution to Problem

The stability evaluation test device for an electric storage device according to the present invention is a stability evaluation test device for an electric storage device, which performs a stability evaluation test on an electric storage device, this stability evaluation test device including: an operation/test control unit that sets an SOC of a test electric storage device to be tested to a value established beforehand, and sets an SOC of a thermal standard electric storage device for comparison to a value lower than that of the SOC of the test electric storage device; a test data collection unit that measures a temperature of the test electric storage device and a temperature of the thermal standard electric storage device; and an evaluation and analysis unit that calculates respective self-generated heat amounts of the test electric storage device and the thermal standard electric storage device on the basis of the temperatures of electric storage devices measured by the test data collection unit, and evaluates the stability of the test electric storage device on the basis of a ratio of the self-generated heat amounts of the test electric storage device and of the thermal standard electric storage device.

The stability evaluation test method for an electric storage device according to the present invention is a stability evaluation test method executed in a stability evaluation test device for an electric storage device, which performs a stability evaluation test on an electric storage device, this method including: a step of setting an SOC of a test electric storage device to be tested to a value established beforehand; a step of setting an SOC of a thermal standard electric storage device for comparison to a value lower than that of the SOC of the test electric storage device; a step of measuring a temperature of the test electric storage device and a temperature of the thermal standard electric storage device; a step of calculating respective self-generated heat amounts of the test electric storage device and the thermal standard electric storage device on the basis of the temperatures of the electric storage devices measured by the test data collection unit; and a step of evaluating the stability of the electric storage device on the basis of a ratio of the self-generated heat amounts of the test electric storage device and of the thermal standard electric storage device.

### Advantageous Effects of Invention

The stability evaluation test device and the stability evaluation test method for an electric storage device according to the present invention involve setting an SOC of a test electric storage device to be tested to a value established beforehand, setting an SOC of a thermal standard electric storage device for comparison to a value lower than that of the SOC of the test electric storage device, calculating respective self-generated heat amounts of the test electric storage device and the thermal standard electric storage device on the basis of the measured temperature of the test electric storage device and the measured temperature of the thermal standard electric storage device, and evaluating the stability of the test electric storage device on the basis of a ratio of the self-generated heat amounts of the test electric storage device and of the thermal standard electric storage device.

Accordingly, a stability evaluation test device and a stability evaluation test method for an electric storage device can be provided that make it possible to evaluate quantitatively the stability of the electric storage device.

### BRIEF DESCRIPTION OF DRAWINGS

FIG. 1 is a block diagram illustrating a schematic configuration of a stability evaluation test device for an electric storage device according to Embodiment 1 of the present invention.

FIG. 2 is a perspective-view diagram illustrating the configuration of a stability evaluation test device for an electric storage device according to Embodiment 1 of the present invention.

FIG. 3 is a flowchart illustrating a test process of a stability evaluation test device for an electric storage device according to Embodiment 1 of the present invention.

FIG. 4 is a cross-sectional schematic diagram illustrating a cylindrical lithium ion battery according to Embodiment 1 of the present invention.

FIG. 5 is an explanatory diagram illustrating the temporal evolution of the temperature of a reference battery and the temperature of a thermal standard battery during a heating test according to Example 1 of the present invention.

FIG. 6 is an enlarged diagram of FIG. 5, illustrating the temporal evolution of temperature during a heating test according to Example 1 of the present invention.

FIG. 7 is an explanatory diagram illustrating the temporal evolution of the temperature of a reference battery and the temperature of a test battery during a heating test according to Example 1 of the present invention.

FIG. 8 is an enlarged diagram of FIG. 7, illustrating the temporal evolution of temperature during a heating test according to Example 1 of the present invention.

FIG. 9 is an explanatory diagram illustrating an A-value during a heating test according to Example 1 of the present invention.

FIG. 10 is an explanatory diagram illustrating the temporal evolution of a temperature difference between a reference and test batteries at respective SOCs during a heating test according to Example 3 of the present invention.

FIG. 11 is an explanatory diagram illustrating test results of a heating test according to Example 3 of the present invention.

FIG. 12 is an explanatory diagram illustrating test results of a heating test according to Example 5 of the present invention.

### DESCRIPTION OF EMBODIMENTS

Preferred embodiments of the stability evaluation test device and stability evaluation test method of an electric storage device according to the present invention will be explained next with reference to accompanying drawings. Identical or corresponding portions in the various figures will be explained using identical reference symbols.

### Embodiment 1

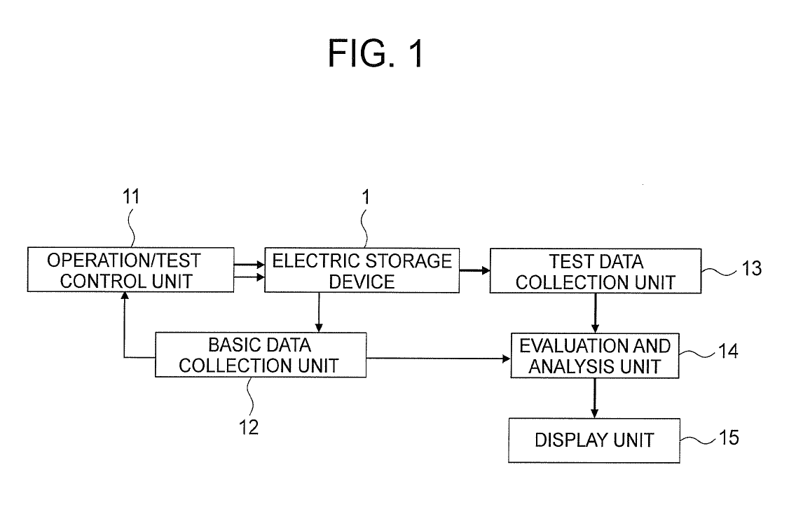

FIG. 1 is a block diagram illustrating a schematic configuration of a stability evaluation test device for an electric storage device according to Embodiment 1 of the present invention. In FIG. 1 the stability evaluation test device is a device that performs a stability evaluation test on an electric storage device 1 (body) to be tested and that is provided with an operation/test control unit 11, a basic data collection unit 12, a test data collection unit 13, an evaluation and analysis unit 14 and a display unit 15.

The operation/test control unit 11 performs external operations on the electric storage device 1, for instance heating, charging, short-circuiting, nail penetration and the like. The basic data collection unit 12 collects basic characteristic data of the electric storage device 1 before testing. The basic characteristic necessary for the test is determined in the operation/test control unit 11 in accordance with the test type, and data from the basic data collection unit 12 is fed back to the operation/test control unit 11, to be reflected on test control. Data such as the capacity, impedance, voltage, temperature and so forth of the test battery are collected in the basic data collection unit 12.

The test data collection unit 13 actually collects measurement data during testing, as prompted by a command from the operation/test control unit 11. The evaluation and analysis unit 14 evaluates and analyzes the collected data. The display unit 15 displays the analysis results. The data collected in the basic data collection unit 12 is stored as basic data of the evaluation and analysis unit 14.

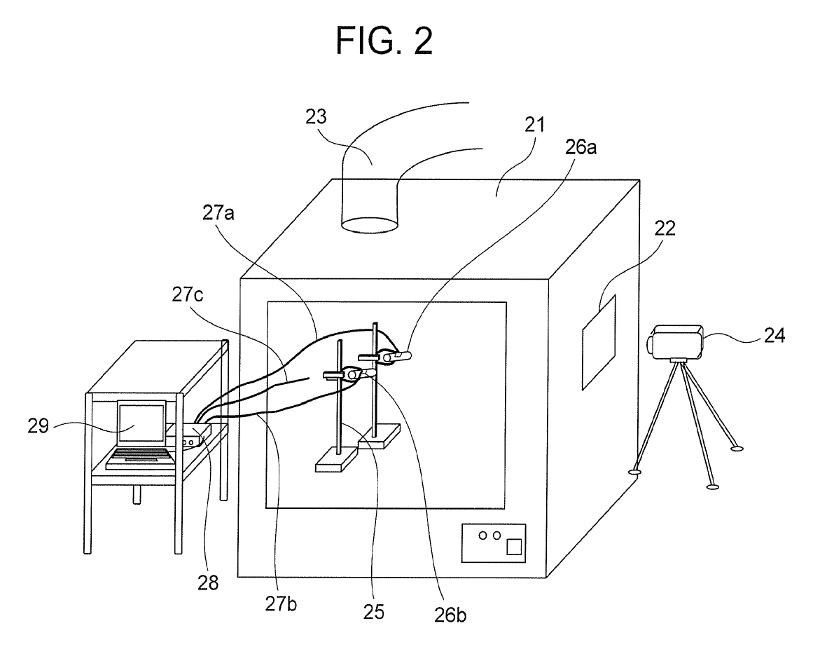

FIG. 2 is a perspective-view diagram illustrating the configuration of the stability evaluation test device for an electric storage device according to Embodiment 1 of the present invention. Herein there is depicted the configuration of a heating test device for a small-size lithium ion battery, being an example of an electric storage device, in a thermal stability evaluation test device in a case where the type of the stability evaluation test is a heating test.

In FIG. 2, an oven 21 is provided with a heating mechanism. The heating mechanism is not particularly limited so long as the battery can be heated, and may be herein a circulation-type hot air furnace, a thermostatic bath, a blow oven or the like. The heating temperature range is preferably set so that the battery can be heated from room temperature to 200° C. or above. Preferably, the heating rate can be arbitrarily regulated to lie in the range from 0.01 to 10° C./min.

The oven 21 has a door and an observation window 22 (transparent window), such that the state of the electric storage device (hereafter also referred to as “battery”) during testing can be monitored from outside the oven 21. An exhaust duct 23 for evacuating gas generated during testing is connected to the ceiling portion of the oven 21.

A video camera 24 that monitors the state of the battery is provided outside the observation window 22. It suffices herein that the video camera 24, which is a CCD camera or the like, be capable of monitoring and recording the state of the battery during testing, via the observation window 22 of the oven 21. Monitoring of the state of the battery involves herein not only simply imaging the battery, but monitoring also the pressure and amount of released gas, if any.

Inside the oven 21 there are provided two clamps 25 that clamp and a reference battery 26a and a test battery 26b, respectively.

Thermocouples 27a, 27b for temperature measurement are attached to the surface of the reference battery 26a and the test battery 26b. Data is collected at a data logger 28 that is provided outside the oven 21 and to which the thermocouples 27a, 27b for temperature measurement are connected. The tips of the thermocouples are attached to the surface of the battery using a heat-resistant tape such as Kapton tape, but preferably the attachment section of the thermocouples is for instance covered using a heat insulating material or the like, to avoid the influence of the atmosphere.

A thermocouple 27c that is disposed separately from the thermocouples 27a, 27b measures the environment temperature at a location sufficiently spaced apart so as not to be affected by the heat generated by the battery. The thermocouple 27c is similarly connected to the data logger 28, and data is input to the latter, to regulate the temperature through feedback to the temperature regulation function of the oven 21. The data collected in the data logger 28 is input to a PC 29 and is analyzed in the evaluation and analysis unit 14 in the PC 29.

Temperature measurement is not limited herein to thermocouples, and any elements such as thermistors or resistance temperature detectors may be used instead, so long as temperatures from about 0 to 1000° C. can be detected and the detect result be output. Temperature measurement may be performed not only on the surface of the battery to be tested, but also inside the battery, and at battery terminal sections; the temperature of the environment in the vicinity of a gas release valve may also be measured.

The measurement site may be not one site alone, but a plurality of sites. In Embodiment 1 the thermocouples 27a, 27b are attached to a body section of the surface of the battery, but in cases of large-capacity batteries or the like, the thermocouples may be attached to the terminal sections or the vicinity of the terminal sections, in order to measure more accurately the temperature inside the battery.

In a case where the voltage or impedance of the reference battery 26a and the test battery 26b is to be monitored, Ni tabs or the like may be welded to the positive and negative electrodes of the battery, and the tabs be pinched with clips or the like provided with a lead wire, for monitoring in the data logger 28 or the like. In this case, a cable for voltage measurement is connected to the Ni terminal, and the cable is connected to the data logger 28 by way of a through-hole (not shown) of a flange or the like on the wall surface of the oven 21.

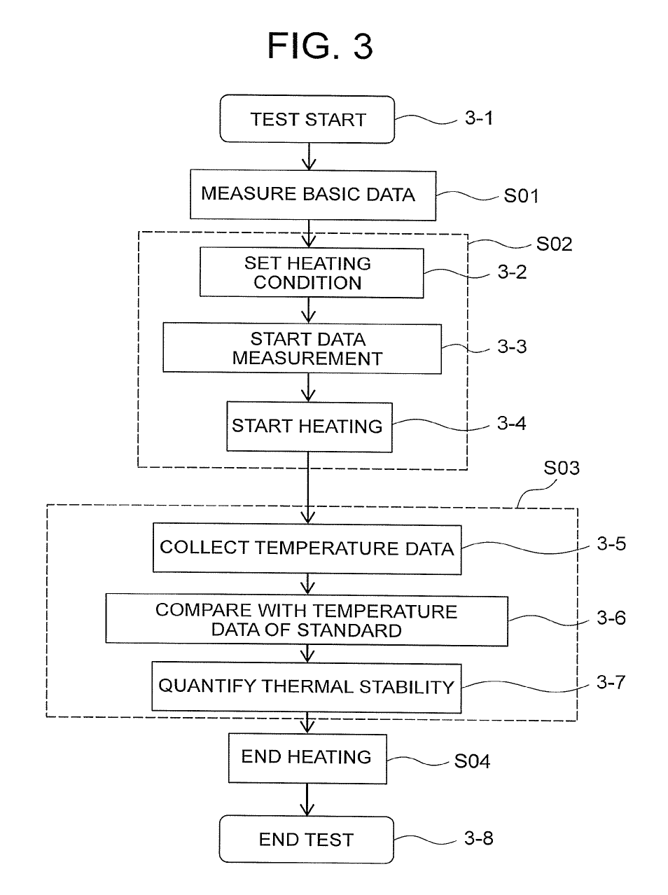

FIG. 3 is a flowchart illustrating a test process of the stability evaluation test device for an electric storage device according to Embodiment 1 of the present invention. A test process will be illustrated herein for a thermal stability evaluation test device in a case where the type of the stability evaluation test is a heating test.

Firstly, the basic data of the test battery are measured upon start of the test (step S01). In this step the charge-discharge capacity of the electric storage device 1 for testing is measured, upon the start of the test, on the basis of a command from the operation/test control unit 11. In some instances there are measured not only the charge-discharge capacity, but also the impedance and DC internal resistance of the electric storage device, as well as the external dimensions of the electric storage device.

In the step of measuring the charge-discharge capacity of the electric storage device 1, the charge-discharge capacity is measured by providing a charge-discharge capacity measurement unit (not shown) connected to the electric storage device 1 and the operation/test control unit 11 illustrated in FIG. 1. In some instances, however, capacity measurement and other measurements may be performed at some other location, before the thermal stability evaluation test, or after the test. Further, measurements may be omitted in cases where measured values are known.

A step of starting the heating test is executed next (step S02). Specifically, a heating condition is set, measurement of data on temperature, voltage and so forth is initiated, and heating is started. Herein, a temperature raise condition may involve a method of heating steadily at a constant rate, or may be a condition according to which the temperature is controlled to rise at a constant rate up to a given set temperature, and once the set temperature has been reached, that temperature is maintained thereafter.

The heating method is not particularly limited, and may involve hot-air heating, heater heating, electromagnetic induction heating, dielectric heating, infrared heating and the like. The heating method is not limited so long as the electric storage device 1 is heated by being continuously imparted with a given amount of heat, and there is a mechanism which controls that amount of heat.

A step of thermal stability evaluation is executed next (step S03). Specifically, measurement data is collected, and data on a thermal standard battery and data on the test battery are subjected to comparative analysis, to quantify thermal stability.

The main evaluation characteristic for comparison involves herein the change in battery temperature with time, but battery voltage, impedance, battery internal pressure and the like may likewise serve as quantification indicators, depending on the circumstances. In a case where the type of the stability evaluation test of the electric storage device 1 is for instance an external short-circuit test, the evaluation characteristics for comparison are not only temperature and battery voltage, but may include current and so forth.

Next, heating is terminated once quantification of thermal stability by the evaluation and analysis unit 14 is complete (step S04). The test is terminated after the temperature has dropped to a predetermined battery temperature.

Although the relevant details are explained further on, the SOC (state of charge) of the thermal standard battery is set to be lower than the SOC of the test battery, preferably to 50% or lower. The heat generation amount of the thermal standard battery can be measured, without the occurrence of thermal runaway, through setting of a low SOC of the thermal standard battery; hence, it becomes possible to compare the heat generation amount with respect to that of the test battery having a high SOC. The storing SOC of the electric storage device ranges ordinarily from about 0 to 40%, and accordingly may be set to the recommended storing SOC of the battery. A value of 0% as well is recommended as the discharge state. Preferably, the SOC of the test battery is set ordinarily to 100%, but to evaluate for instance the dependence of stability on SOC it is preferable to produce and evaluate several batteries having different SOCs.

The step (step S03) of thermal stability evaluation mentioned above will be explained in detail next. Firstly, a heating test of the thermal standard battery for comparison is carried out in order to acquire temperature data of the thermal standard battery. In this method, the heating test of the thermal standard battery is carried out before that of the test battery. By heating simultaneous a reference having a heat capacity identical to that of the thermal standard battery and the test battery, during heating of the foregoing, it becomes possible to calculate accurately the self-generated heat amount of each battery.

In this case, the temperature distribution within the oven 21 is preferably uniform, and the arrangement distance between the test battery and the thermal standard battery is set to be at least 100 mm or greater. That is because heat input into the reference, arising from the self-generated heat of the test battery, might influence the precision of derivation of thermal stability. When resorting to direct heating for instance using a heater, instead of by oven heating, the amount of heat that is imparted to the batteries and the reference must be equalized.

As the reference there is preferably used a battery identical to the thermal standard battery and the test battery, in a state where no potential operation has been performed after injection. Preferably, the reference (for instance pure aluminum or alumina) has a known heat capacity that is identical to that of the test battery.

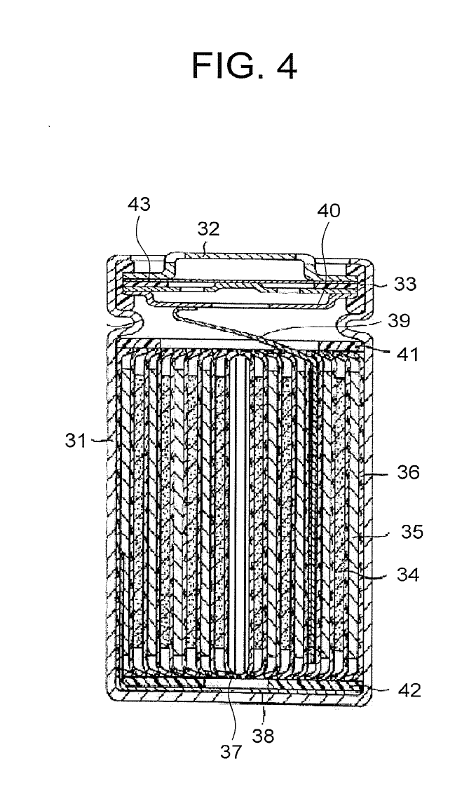

FIG. 4 is a cross-sectional schematic diagram illustrating a cylindrical lithium ion battery according to Embodiment 1 of the present invention. The lithium ion battery in FIG. 4 has a sealed structure resulting from crimping together an exterior can 31, a sealing lid 32 and gasket 33. The sealing lid 32 constitutes ordinarily a positive electrode terminal.

A stack resulting from laying up a positive electrode 34, a negative electrode 35 and a separator 36 is wound, to yield a battery body. A core rod 37 is inserted into the center of the battery body. A negative electrode terminal is formed through welding of a negative electrode tab 38 and the exterior can 31. The positive electrode tab 39 is welded to a safety valve 40 that is activated in response to a rise in pressure inside the battery.

An upper insulating plate 41 and a lower insulating plate 42 fulfill the function of preventing contact between the battery and the can wall and between the battery body and the safety valve 40. A heat resistor 43 having for instance a PTC (positive temperature coefficient) may be inserted as the case may require.

Examples 1 to 4 of Embodiment 1 will be explained next, and also Comparative example 1 for comparison with Examples 1 to 4. The present invention is however not limited to the examples described below.

### Example 1

In Example 1, a positive electrode active material paste was obtained by mixing 96 wt % of lithium cobaltate (LiCoO₂), as a positive electrode active material, 1.5 wt % of acetylene black, as a conductive aid, and a solution of PVDF (polyvinylidene difluoride) as a binder in NMP (N-methylpyrrolidone) so as to yield a proportion of PVDF of 2.5 wt % with respect to the total, with 4 wt % dispersion in NMP as a dispersion medium, to yield a positive electrode active material paste.

To obtain a positive electrode, the positive electrode active material paste was applied onto both faces of an 18 μm thick aluminum foil, which is a positive electrode collector, and dried at 115° C., followed by pressing using a press to adjust the porosity of the positive electrode.

A negative electrode active material paste was produced through mixing of 97 wt % of spherical artificial graphite as a negative electrode active material, styrene butadiene rubber (SBR) as a binder, a carboxymethyl cellulose (CMC) solution as a thickener, and water.

To obtain a negative electrode, the negative electrode active material paste was applied onto both faces of a 14 μm thick copper foil, which is a negative electrode collector, and dried at 110° C., followed by pressing in a press to adjust the porosity of the negative electrode.

The positive electrode tab 39 made of aluminum was attached to the collector of the positive electrode 34, and the negative electrode tab 38 made of nickel was attached to the collector of the negative electrode 35. Thereafter, the separator 36 comprising a microporous membrane of polyethylene was wound between the positive electrode 34 and the negative electrode 35, to construct a battery body.

The battery body was accommodated within the exterior can 31 of iron plated with nickel, and the core rod 37 was inserted into the center of the battery body. The lower insulating plate 42 was disposed below the battery body, and the negative electrode terminal was welded to the inner side of the exterior can 31. The upper insulating plate 41 was disposed after the above welding.

A positive electrode lead was welded thereafter to the internal pressure-actuated safety valve 40, and an electrolyte solution in the form of a 1 mol/l solution of lithium hexafluorophosphate in a mixed solvent of ethylene carbonate/diethyl carbonate was injected at reduced pressure. Next, the open end of the exterior can 31, being the battery container, was sealed with the sealing lid 32, via the gasket 33, to produce as a result a cylindrical lithium ion battery. This battery after injection was used as a reference battery.

A battery produced in the same way was pre-charged at low current over 2 hours, and thereafter, the battery was charged up to 4.2 V at 0.2 It (1 It is the current value at which the total electric storage capacity of the electric storage device is discharged in 1 hour) over 3 hours, to SOC 100%. The battery was discharged thereafter at 0.2 It down to 2.5 V to SOC 0% to work out the discharge capacity of the battery. The result was 2200 mAh.

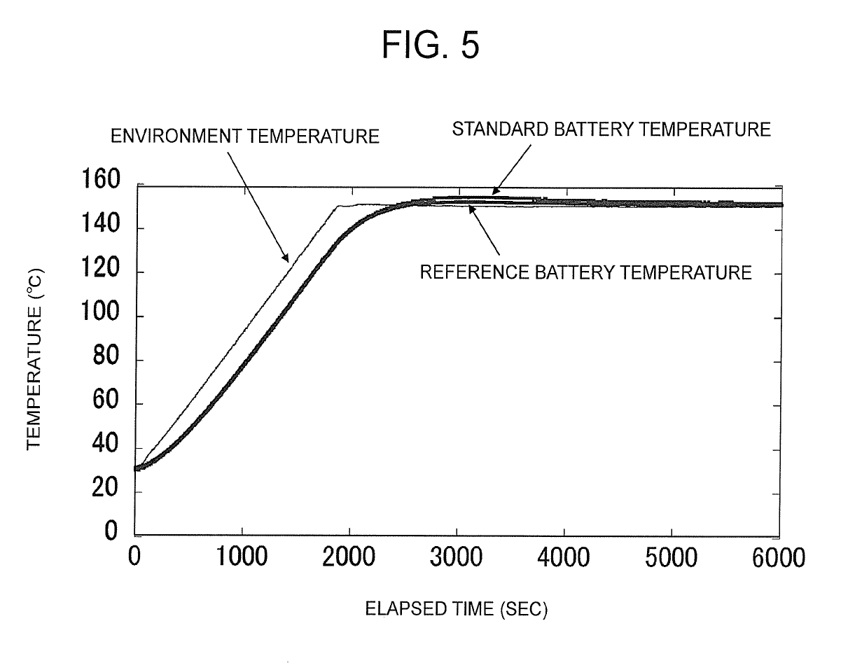

Using this battery as a thermal standard battery, the reference battery and the thermal standard battery were disposed clamped in a circulation oven at 30° C., respective thermocouples were attached, and the whole was left to stand for 2 hours. Thereafter, the temperature was raised up to 150° C. at a rate of temperature rise of 4° C./min; the temperature was held next at 150° C. for 3 hours, and was then lowered. FIG. 5 illustrates the environment temperature, reference battery temperature and thermal standard battery temperature with respect to elapsed time in this case.

In FIG. 5 the environment temperature is the temperature in a space about 50 mm away from the thermal standard battery, and is the output of the thermocouple for temperature regulation of the oven. The temperature of the reference battery and the thermal standard battery rose delayed with respect to the environment temperature, at substantially the same rate as that of the environment temperature, and reached thereafter 150° C. with a delay of about 500 seconds with respect to the environment temperature. The temperatures became thereafter substantially constant.

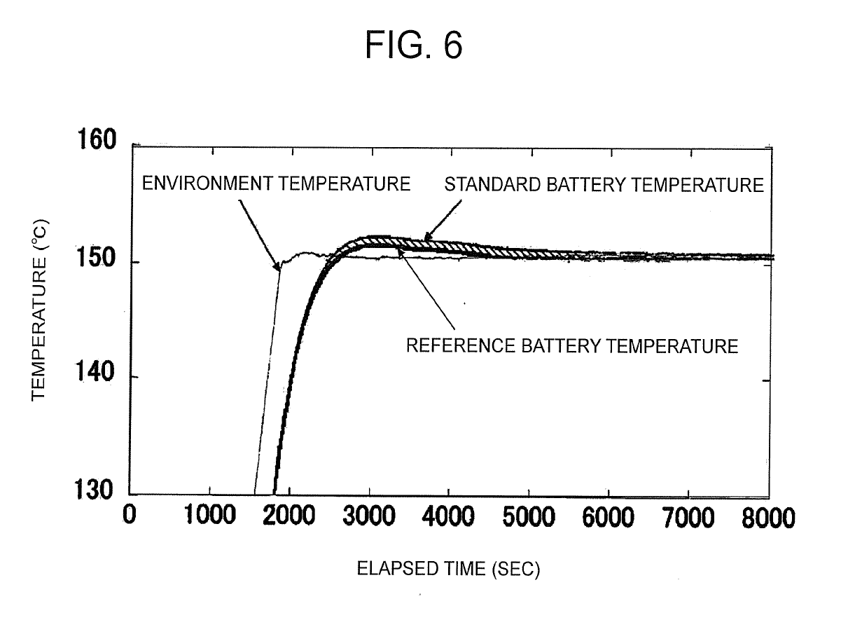

FIG. 6 is an enlarged diagram of FIG. 5, illustrating the temporal evolution of temperature during the heating test according to Example 1 of the present invention. In FIG. 6, a temperature profile of the thermal standard battery transitions to a higher temperature than the temperature profile of the reference battery. The temperature difference (hatched portion illustrated in the figure) between the thermal standard battery and the reference battery represents the difference in the heat generation rate for a same heat capacity. The surface area of the hatched portion is given Expression (1) below, as a relative self-generated heat amount.

Q1=C×∫t0→t1(Ti−T0)dt (1)

In Expression (1), C denotes the heat capacity of the reference and of the thermal standard battery, t0 denotes the time at the start of heating, t1 denotes the time after 3 hours have elapsed since the battery temperature reached a set temperature, Ti denotes the temperature of the thermal standard battery, and T0 denotes the temperature of the reference battery. The thermal standard battery temperature data with respect to time in this case was input beforehand in the evaluation and analysis unit 14 of the stability evaluation test device (see FIG. 1).

Next, the produced battery was pre-charged over 2 hours at constant current, in the same way as in the case of the reference battery; thereafter, the battery was charged up to 4.2 V at 0.2 It over 3 hours, and was discharged at 0.2 It down to 2.5 V, to measure the discharge capacity. This battery was charged over 3 hours at 0.2 It up to 4.2 V, to SOC 100%, to yield a test battery.

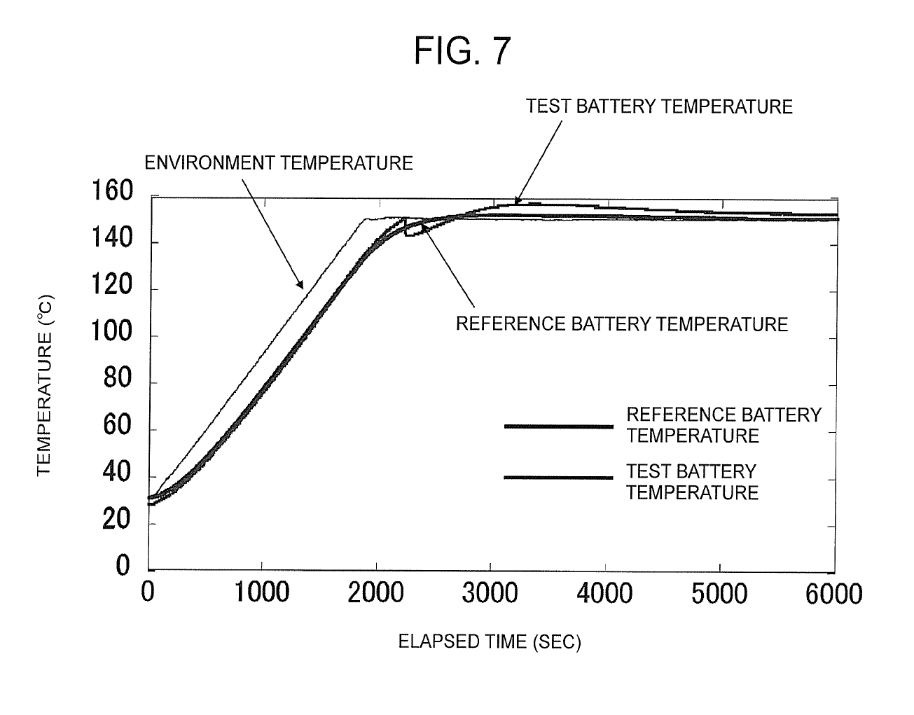

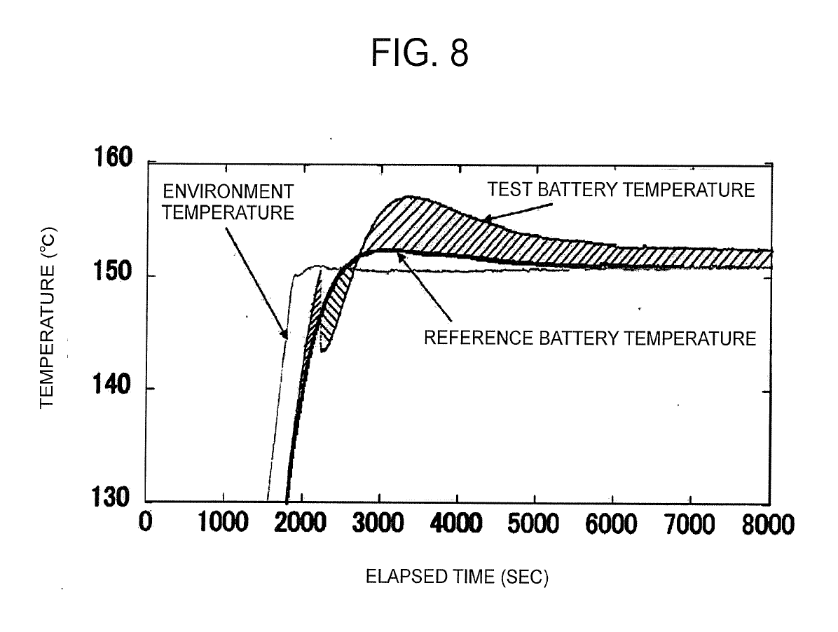

The reference battery and the test battery were disposed clamped in a circulation oven at 30° C., respective thermocouples were attached, and the whole was left to stand for 2 hours. Thereafter, the temperature was raised up to 150° C. at a rate of temperature rise of 4° C./min; the temperature was held next at 150° C. for 3 hours, and was then lowered. FIG. 7 illustrates the environment temperature, reference battery temperature and thermal standard battery temperature with respect to elapsed time in this case. FIG. 8 is an enlarged diagram of FIG. 7.

In FIGS. 7 and 8, the temperature profile of the test battery rises rapidly up to 150° C., drops sharply thereafter, and rises sharply once more. That is because the crimped portion of the positive electrode opens due to the rise in pressure inside the battery, and the internal pressure is relieved as a result. The self-generated heat amount of the test battery at this time was calculated according to Expression (2), as the difference (hatched portion in the figure) with respect to the reference battery. The self-generated heat amount was calculated as a negative value at a portion of lower temperature than that of the reference battery.

Q2=C×∫t0→t2(Ti−T0)dt (2)

In Expression (2), C denotes the heat capacity of the reference and of the test battery, t0 denotes the time at the start of heating, t2 denotes the time after 3 hours have elapsed since the battery temperature reached a set temperature, Ti denotes the temperature of the test battery, and T0 denotes the temperature of the reference battery.

The ratio of the self-generated heat amount of the thermal standard battery and the self-generated heat amount of the test battery is A=Q2/Q1; herein, thermal stability can be quantified according to the magnitude of the A-value.

Specifically, the thermal stability of the electric storage device in the heating test can be determined through quantification of the thermal stability on the basis of the magnitude of the self-generated heat amount of the electric storage device, factoring in the ambient environment and the state of the electric storage device body. The ambient environment refers to heat dissipation from the electric storage device at the time of the heating test.

The state of the electric storage device body denotes conceivable factors that affect thermally the electric storage device, for instance structural safety functions of the electric storage device (safety valve, shutdown function of the separator, PTCs and the like), the strength of the exterior can, and the internal structure of the electric storage device. The ambient environment and the state of the electric storage device body are factored into the self-generated heat amounts Q1 and Q2 calculated using the temperature data of the electric storage device.

Therefore, not only the mere thermal stability of the electric storage device but also the safety of the electric storage device are represented through numerical quantification of the ratio A=Q2/Q1 of the self-generated heat amount of the thermal standard battery and the self-generated heat amount of the test battery. An evaluation indicator of safety is therefore given herein by whether a self-generated heat amount is several times the self-generated heat amount, at a certain SOC serving as a reference.

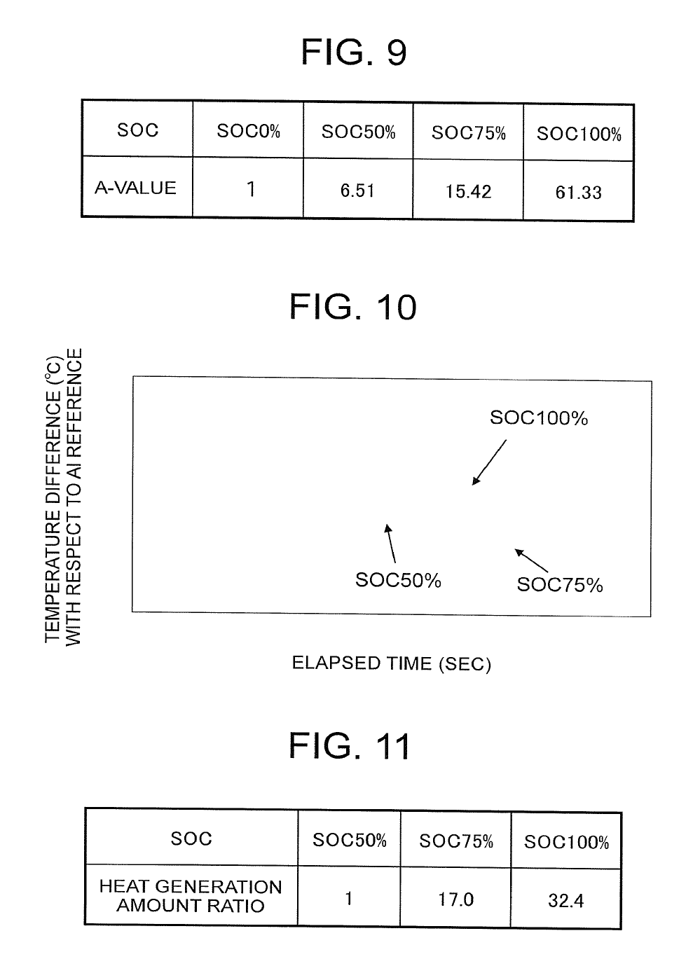

The same heating test was performed for test batteries with SOC 75% and SOC 50%, in accordance with the above procedures, to determine A-values. FIG. 9 illustrates respective A-values at SOC 50%, SOC 75% and SOC 100%, with the A-value at SOC 0% set to 1. In FIG. 9, the thermal stability of the test battery is found to drop increasingly rapidly in the order SOC 0%, 50%, 75% and 100%, in particular in the case of SOC 100%.

### Example 2

As the thermal standard battery and the test battery in Example 2 a lithium ion battery was produced that had a positive electrode and negative electrode different from those of Example 1. The lithium ion battery was produced in the same way as in Example 1, but herein the positive electrode was obtained by coating an aluminum collector foil, 16 μm thick, with a positive electrode active material paste having lithium cobaltate identical to that of Example 1, but in a coating amount per unit surface area that was 1.5 times that of Example 1.

The negative electrode was produced in the same way as in Example 1, but herein a copper collector foil, 8 μm thick, was coated with a negative electrode active material paste in a coating amount that was 1.5 times that of Example 1. Next, a cylindrical lithium ion battery was produced in the same way as in Example 1 using the above positive electrode, negative electrode and separator.

Next, the lithium ion battery was subjected to a heating test in the same way as in Example 1, with the SOC of the thermal standard battery set to 0°, and the SOC of the test battery set to 100%. With the A-value of the thermal standard battery set to 1, the result of the test yielded an A-value of the test battery of 135.2, which was 2 or more times higher than that of the test battery at SOC 100% in Example 1.

Therefore, it can be seen that the thermal stability of the lithium ion battery of Example 2 is lower, since the A-value is higher than that of the lithium ion battery of Example 1. It is thus possible to quantitatively compare thermal stabilities also in batteries of different types, by comparing the ratio (A-value) of the self-generated heat amount of the thermal standard battery and the self-generated heat amount of the test battery.

### Example 3

In Example 3 an instance will be explained where the thermal stability of a test battery is quantified by using a known substance, not a battery, as the reference. Lithium ion batteries at respective SOCs were produced in the same way as in Example 1, but using herein, as a reference, an aluminum-made cylinder having a mass identical to that of the lithium ion battery produced in Example 1, and the test was performed in a similar manner using a battery at SOC 0% as a thermal standard battery and batteries at SOC 50, 75 and 100% as test batteries.

FIG. 10 is an explanatory diagram illustrating the temporal evolution of a temperature difference between the reference and test batteries at respective SOCs during a heating test according to Example 3 of the present invention. In FIG. 10 the temperature difference between the reference and the test batteries at respective SOCs is plotted with respect to the elapsed time. Heat absorption and release at the time of rising of the temperature of the test batteries can be evaluated through plotting of the temperature difference with respect to the reference.

In FIG. 10, the batteries at SOC 50% and 75% exhibit heat absorption, with a negative temperature with respect to that of the reference after the rise in temperature. Therefore, the respective surface areas were calculated assuming heat generation for those portions exhibiting a positive value with respect to the reference, the battery of SOC 50% was set as the thermal standard battery, and the surface area ratio with respect to the latter was worked out, to yield a heat generation amount ratio.

FIG. 11 is an explanatory diagram illustrating test results of a heating test according to Example 3 of the present invention. FIG. 11 illustrates a heat generation amount ratio of the test batteries at respective SOCs. FIG. 11 reveals that the heat generation amount ratio is higher for SOC 75% and 100% than for SOC 50%. Thermal stability can be quantitatively compared also for batteries of different types, by using the above heat generation amount ratio.

### Comparative Example 1

In Comparative example 1 a lithium ion battery X having a rated capacity of 10 Ah and a nominal voltage of 3.7 V was charged for 3 hours at 0.2 It up to 4.2 V, to SOC 100%. Next, the battery was disposed inside an oven; the temperature was then raised up to 150° C. at a rate of 3° C./rain, and the temperature was held for 3 hours. Thereafter, similarly to Example 1, an aluminum-made reference having a heat capacity identical to that of the battery was disposed in the oven, and the batteries were heated simultaneously. The value of ∫t1→t2(Ti−T0)dt calculated in Expression (1) on the basis of the surface area difference with respect to the reference was 9300° C.·sec.

Next, a lithium ion battery Y having a rated capacity of 1.2 Ah and a nominal voltage of 3.7 V was charged for 3 hours at 0.2 It up to 4.2 V, to SOC 100%. Next, this battery was disposed inside an oven; the temperature was then raised up to 150° C. at a rate of 3° C./min, and the temperature was held for 3 hours, in the same way as in battery X. The value of ∫t1→t2(Ti−T0)dt was herein 7520° C.·sec.

Based on comparison between the values of ∫t1→t2(Ti−T0)dt for these two batteries, expectation was made that the battery X would exhibit a larger value and thus the self-generated heat amount thereof would be larger. A similar test was performed setting the heating upper limit temperature of the batteries to 155° C. The test resulted in ignition of battery Y. It is thus ostensibly not possible to grasp the accurate thermal stability of the electric storage device only on the basis of a simple comparison of self-generated heat amounts.

### Example 4

In Example 4, the lithium ion batteries of Comparative example 1 described above were charged over 3 hours at 0.2 It up to 4.2 V, to SOC 100%. Thereafter, the batteries were discharged at 0.2 It down to 2.5 V, to SOC 0% to yield standard batteries X and Y.

Thereafter, an aluminum-made reference having a heat capacity identical to that of thermal standard battery X was disposed in the oven, in the same way as in Comparative example 1, and the temperature was raised up to 150° C. at 3° C./min, and was held thereafter at 150° C. The value of ∫t1→t2(Ti−T0)dt in Expression (1) was herein 2640° C.·sec.

Thereafter, an aluminum-made reference having a heat capacity identical to that of thermal standard battery Y was disposed in the oven, in the same way as in Comparative example 1, and the temperature was raised up to 150° C. at 3° C./rain, and was held thereafter at 150° C. The value of ∫t1→t2(Ti−T0)dt was herein 870° C.·sec.

The A-value of the lithium ion batteries X and Y was worked out through a comparison with the Q of the respective standard batteries. The value for battery X is 3.52 and for the battery Y is 8.64. The value is larger for battery Y, which is indicative of lower thermal stability.

### Example 5

In Example 5, a commercially available cylindrical lithium ion battery having a rated capacity of 1.8 Ah and a nominal voltage of 3.6 V was charged for 3 hours at 2 It up to 4.2 V, to SOC 100%. The battery was discharged thereafter at 0.2 It down to 2.75 V to SOC 0%, to work out the discharge capacity of the battery. The result was 1.81 Ah. This battery was used as a thermal standard battery.

A battery identical to this battery was charged for 3 hours at 0.2 It up to 4.2 V, to yield test battery C having SOC 100%. The impedance at 25° C. and 0.1 Hz of this test battery C at SOC 0% was 90 mΩ).

A battery identical to this battery was repeatedly charged and discharged at 0.5 It over 200 cycles, from 2.5 V to 4.2 V in an environment at 25° C. The discharge capacity after the charge and discharge cycles was 1.31 Ah (this battery was test battery D). The impedance at 0.1 Hz of the battery after the cycles was 136 mΩ.

A battery identical to this battery was repeatedly charged and discharged at 1 It over 100 cycles, from 2.5 V to 4.2 V, in an environment at 5° C. The discharge capacity after the cycles was 1.30 Ah (this battery was test battery E). The impedance at 0.1 Hz of the battery after the cycles was 91 mΩ).

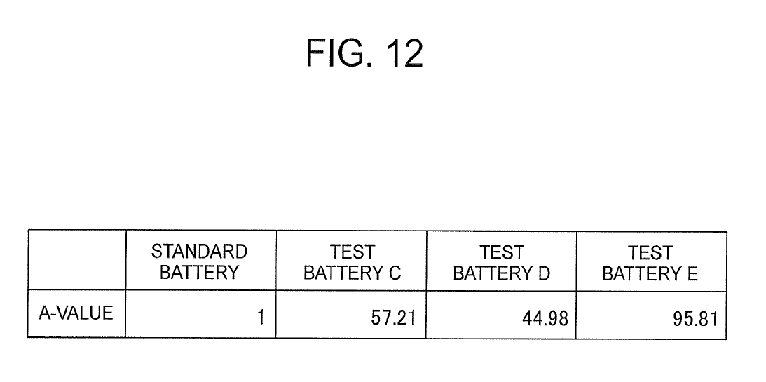

An aluminum-made cylinder having a heat capacity identical to that of the batteries was used as herein a reference. The thermal standard battery was disposed clamped in a circulation oven at 30° C., respective thermocouples were attached, and the whole was left to stand for 2 hours. Thereafter, the temperature was raised up to 150° C. at a rate of temperature rise of 4° C./rain, and next the temperature was held at 150° C. for 3 hours. The same test was performed on test batteries C, D and E, and the respective A-values were worked out in the same way as in Example 1 for the test results of the foregoing. FIG. 12 illustrates the A-value of the test batteries C, D and E, with the A-value of thermal standard battery set to 1.

The above results reveal that test batteries D and E exhibit similar discharge capacity but a large difference in thermal stability, with a low safety level of test battery E. From the impedances of the batteries at SOC 0%, test battery E is found to exhibit degradation in that both impedance and safety level are lower. The above indicates that the present evaluation test device can be used also to discriminate between allowing or forbidding reuse of a degraded electric storage device in use or already used.

In Embodiment 1 and Examples 1 to 5, thus, the SOC of a test electric storage device to be tested is set to a value established beforehand, the SOC of a thermal standard electric storage device for comparison is set to a value lower than the SOC of the test electric storage device, the respective self-generated heat amounts of the test electric storage device and the thermal standard electric storage device are calculated on the basis of the measured temperature of the test electric storage device and the measured temperature of the thermal standard electric storage device, and the stability of the test electric storage device is evaluated on the basis of a ratio of the self-generated heat amounts of the test electric storage device and of the thermal standard electric storage device.

The temperature of the test electric storage device and the thermal standard electric storage device is raised at a constant rate through heating.

During raising of the temperature of the test electric storage device and the thermal standard electric storage device at a constant rate, a reference having a known heat capacity and mass identical to that of the test electric storage device and the thermal standard electric storage device is heated in such a manner that heat input amounts into the electric storage devices and the reference are identical. The stability of the test electric storage devices is evaluated by comparing the temperature characteristic of the electric storage devices with that of the reference.

Accordingly, it becomes possible to evaluate quantitatively the stability of an electric storage device for electric storage devices of different type, use history, and size.

1. A stability evaluation test device for an electric storage device, which performs a stability evaluation test on an electric storage device,
the stability evaluation test device comprising:
an operation/test control unit that sets an SOC of a test electric storage device to be tested to a value established beforehand, and sets an SOC of a thermal standard electric storage device for comparison to a value lower than that of the SOC of the test electric storage device, and heats up the test electric storage device, the thermal standard electric storage device, and a reference having the same heat capacity as those of the test electric storage device and the thermal standard electric storage device;
a test data collection unit that measures a temperature of the test electric storage device, the thermal standard electric storage device and the reference; and
an evaluation and analysis unit that calculates a first self-generated heat amount calculated on the basis of a difference between the temperature of the thermal standard electric storage device and the temperature of the reference, which have been measured by the test data collection unit, and a second self-generated heat amount calculated on the basis of a difference between the temperature of the test electric storage device and the temperature of the reference, which have been measured by the test data collection unit, and that evaluates the stability of the test electric storage devices on the basis of a ratio of the first self-generated heat amount and the second self-generated heat amount.

2. The stability evaluation test device for an electric storage device of claim 1,
wherein the operation/test control unit heats up the test electric storage device, the thermal standard electric storage device and the reference, to cause the temperatures thereof to rise at a constant rate.

3. The stability evaluation test device for an electric storage device of claim 2,
wherein
the test data collection unit measures temperatures at a time when the thermal standard electric storage device, the test electric storage device and the reference have been heated through application of identical amounts of heat by the operation/test control unit.

4. The stability evaluation test device for an electric storage device of claim 1, comprising:
a basic data collection unit that performs measurements necessary for quantification of thermal stability, on the thermal standard electric storage device and the test electric storage device before the start of the stability evaluation test on the electric storage devices, and that collects data, wherein
the evaluation and analysis unit evaluates the stability of the test electric storage device on the basis of the data collected by the basic data collection unit.

5. A stability evaluation test method executed in a stability evaluation test device for an electric storage device, which performs a stability evaluation test on an electric storage device,
the method comprising:
a step of setting an SOC of a test electric storage device to be tested to a value established beforehand;
a step of setting an SOC of a thermal standard electric storage device for comparison to a value lower than that of the SOC of the test electric storage device, and heating the test electric storage device, the thermal standard electric storage device, and a reference having the same heat capacity as those of the test electric storage device and the thermal standard electric storage device;
a step of measuring a temperature of the test electric storage device, the thermal standard electric storage device and the reference;
a step of calculating a first self-generated heat amount calculated on the basis of a difference between the temperature of the thermal standard electric storage device and the temperature of the reference, which have been measured, and a second self-generated heat amount calculated on the basis of a difference between the temperature of the test electric storage device and the temperature of the reference, which have been measured; and
a step of evaluating the stability of the test electric storage device on the basis of a ratio of the first self-generated heat amount and the second self-generated heat amount.
